(19) United States
(12) Patent Application Publication
(10) Pub. No.: US 2021/0042550 A1
(43) Pub. Date: Feb. 11, 2021

(54) INFORMATION PROCESSING DEVICE, INFORMATION PROCESSING METHOD, AND COMPUTER-READABLE RECORDING MEDIUM RECORDING INFORMATION PROCESSING PROGRAM

(71) Applicant: FUJITSU LIMITED, Kawasaki-shi (JP)

(72) Inventors: Tsuyoshi Nagato, Isehara (JP); Hiroaki Okamoto, Atsugi (JP); Tetsuo Koezuka, Hachioji (JP)

(73) Assignee: FUJITSU LIMITED, Kawasaki-shi (JP)

(21) Appl. No.: 17/079,574

(22) Filed: Oct. 26, 2020

Related U.S. Application Data
(63) Continuation of application No. PCT/JP2018/019232, filed on May 18, 2018.

(51) Int. Cl. G06K 9/00; G06K 9/62; G06T 7/00; G06N 20/00

(52) U.S. Cl. CPC G06K 9/00986; G06K 9/6218; G06K 9/628; G06T 2207/20081; G06T 7/0004; G06N 20/00; G06K 9/6262

(57) ABSTRACT

An information processing device includes: a memory; and a processor coupled to the memory and configured to: calculate an image feature amount from a plurality of original images for learning; classify the plurality of original images into each class by performing clustering on the plurality of original images by using the image feature amount; calculate an evaluation value of an image processing program with respect to the plurality of original images for each class; generate an image processing program by genetic programming on a basis of the evaluation value calculated for each class; and store an image processing program of which the evaluation value satisfies a predetermined condition in association with each class.

### CROSS-REFERENCE TO RELATED APPLICATION

This application is a continuation application of International Application PCT/JP2018/019232 filed on May 18, 2018 and designated the U.S., the entire contents of which are incorporated herein by reference.

### FIELD

The embodiment relates to an information processing device, an information processing method, and an information processing program.

### BACKGROUND

A technique that prepares an original image for learning and a target image and automatically generates an image processing program with a high fitness by genetic programming has been disclosed.

Related art is disclosed in Japanese Laid-open Patent Publication No. 2008-299687.

### SUMMARY

According to an aspect of the embodiments, an information processing device includes: a memory; and a processor coupled to the memory and configured to: calculate an image feature amount from a plurality of original images for learning; classify the plurality of original images into each class by performing clustering on the plurality of original images by using the image feature amount; calculate an evaluation value of an image processing program with respect to the plurality of original images for each class; generate an image processing program by genetic programming on a basis of the evaluation value calculated for each class; and store an image processing program of which the evaluation value satisfies a predetermined condition in association with each class.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1(a) to 1(c) are diagrams illustrating image processing.

FIG. 2 is a diagram illustrating a modification of an image processing program.

FIG. 3 is a diagram for explaining an outline of genetic programming.

FIG. 4 is a diagram illustrating genetic processing.

FIG. 5 is a diagram illustrating a fitness.

FIG. 6 is a diagram illustrating evaluation of the image processing program.

FIG. 7 is a block diagram illustrating an entire configuration of an image processing apparatus according to a first embodiment.

FIG. 8 is a diagram illustrating a flowchart indicating each processing executed by an information processing device at the time of learning processing.

FIG. 9 is a diagram illustrating an outline of the learning processing.

FIG. 10 is a diagram illustrating a flowchart indicating each processing executed by the information processing device at the time of inspection processing.

FIG. 11 is a diagram illustrating an outline of the inspection processing.

FIG. 12 is a block diagram for explaining a hardware configuration of the information processing device.

### DESCRIPTION OF EMBODIMENTS

However, there is a case where an image processing program having a high fitness with respect to a specific original image is generated due to a difference in an imaging environment or the like. Because such an image processing program does not have a high fitness with respect to other original images, there is a possibility that the image processing program is eliminated at the time of survival selection. In this case, there is a possibility that a learning time before acquisition of desired accuracy is increased.

In one aspect, an information processing device, an information processing method, and an information processing program that can generate an image processing program with high accuracy in a short time may be provided.

Prior to the description of the embodiment, an outline of appearance inspection will be described.

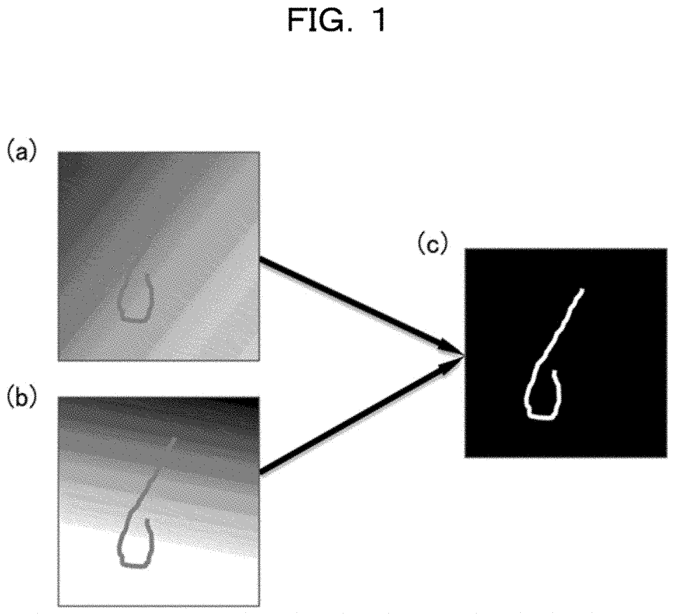

In the appearance inspection, an appearance of an inspection target is imaged by using an imaging device such as a camera, and whether or not the inspection target has a defect is determined. In particular, in the factory automation (FA) field, variation in noises, shadows, brightness, or the like according to an imaging environment of a field often occurs in a captured image. For example, as illustrated in FIGS. 1(a) and 1(b), the brightness may vary. Even in such a case, robust processing against an environmental change is desired for the image processing program. For example, as illustrated in FIG. 1(c), it is desired to obtain similar images from images having different brightness.

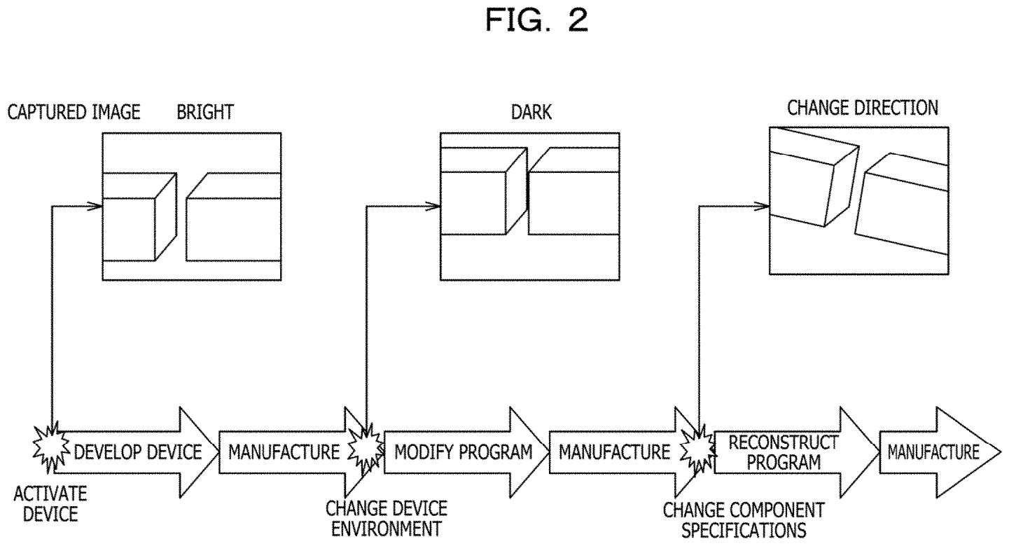

Furthermore, after an inspection device is developed and manufacture of the inspection device is actually started, as illustrated in FIG. 2, there is a case where a device environment such as brightness changes and a recognition rate is lowered. In this case, the image processing program is modified. Furthermore, there is a case where uses of components are changed and an inspection target such as a direction of the component is changed. In this case, the recognition rate is lowered. Therefore, the image processing program is reconstructed. For these modifications and reconstructions, a production line is stopped. Therefore, a technique for rapidly modifying the image processing program has been required.

It is considered to use Genetic Programming (GP) as a method for automatically generating an image processing program. The image processing program includes a plurality of processing programs in order to execute individual image processing. By combining the plurality of processing programs in a tree structure and executing the series of program processing, target image processing can be realized. By executing genetic processing such as crossover or mutation on a group of tree-structure processing programs, an image processing program with a high fitness is generated. The fitness is an index indicating how good an output result of the tree-structure processing program, which is automatically generated, is relative to the target result. In a case where the tree-structure processing program having a fitness equal to or more than a predetermined threshold is obtained, it is assumed that learning be completed. The tree-structure processing programs obtained in that case is an image processing program that executes the target image processing.

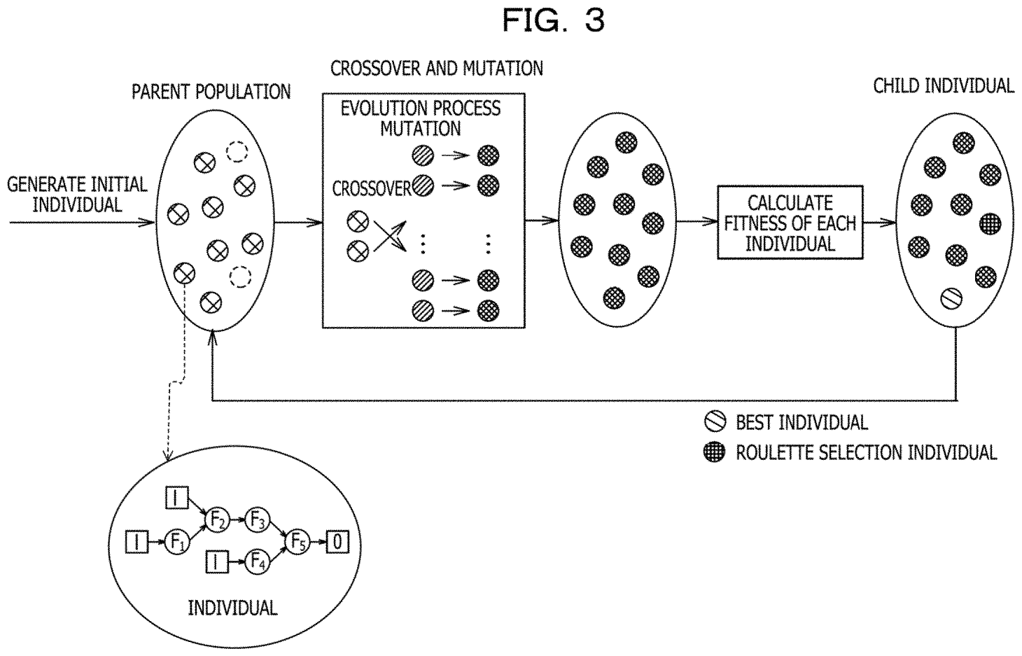

FIG. 3 is a diagram for explaining an outline of the genetic programming. First, a plurality of initial individuals is created. In FIG. 3, each circular “individual” represents an image processing program having tree-structure processing program. In other words, a single individual is a single image processing program and has the tree-structure processing program. In FIG. 3, “F₁” to “F₅” included in the image processing program are processing programs (filter), “I” is an input image, and “O” is an output image. By generating the plurality of initial individuals, it is possible to generate a parent population (set).

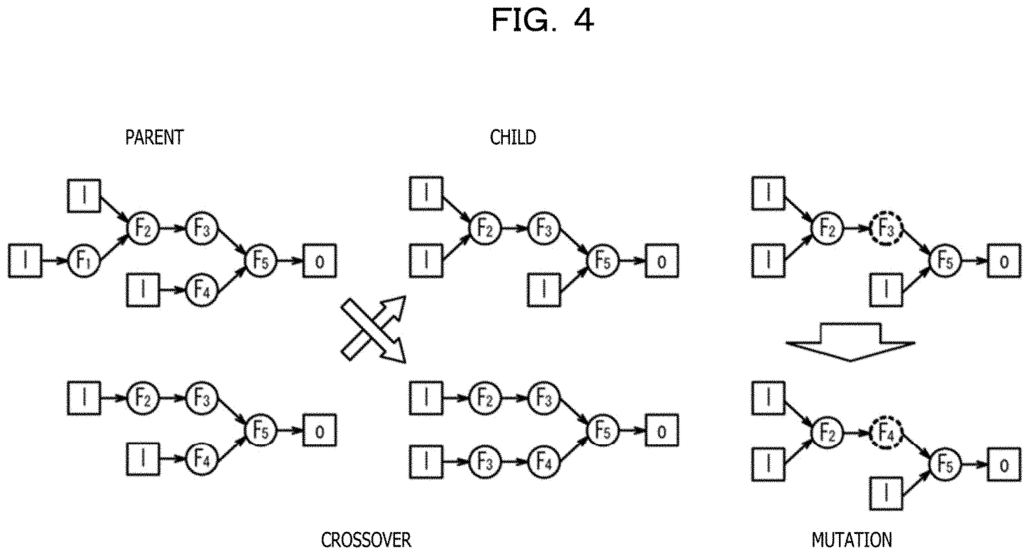

Next, a plurality of individuals is selected and extracted from the parent population. Next, genetic processing is executed on the plurality of extracted individuals so as to generate a plurality of child individuals. The genetic processing is processing for executing the genetic processing such as crossover or mutation on the tree-structure processing program as illustrated in FIG. 4.

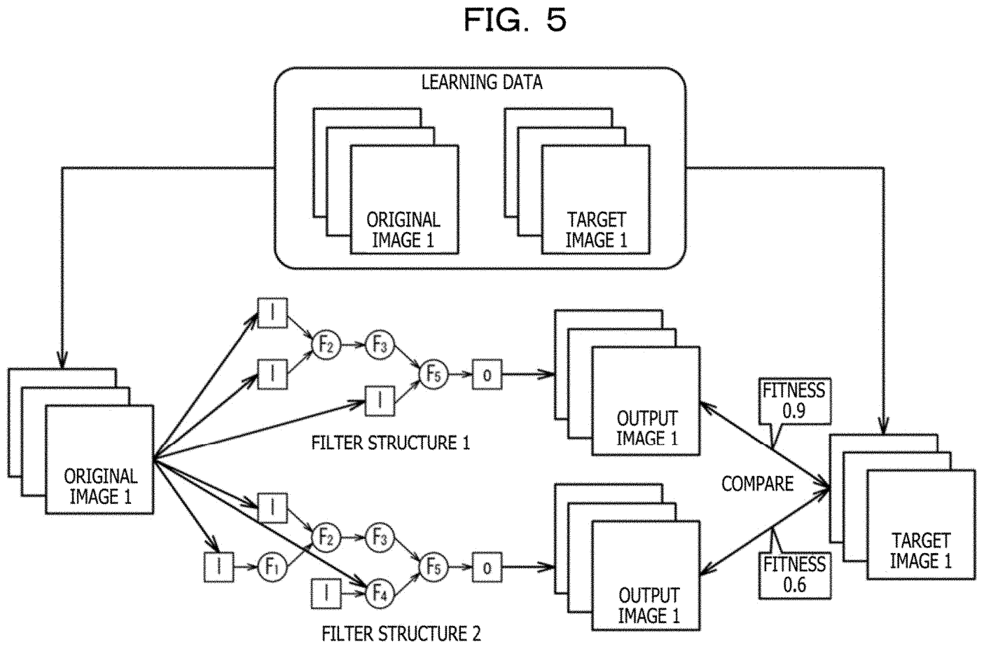

Next, a fitness is calculated for each child individual. FIG. 5 is a diagram illustrating a fitness. First, learning data is prepared. The learning data includes a plurality of original images and a plurality of target images that is an intended result of each original image. For example, target images 1 to N respectively correspond to original images 1 to N. As illustrated in FIG. 5, the fitness can be calculated by processing each individual of the original images 1 to N and respectively comparing output images 1 to N that are processing results with the target images 1 to N. For example, the fitness is an index that increases as similarity between each of the output images 1 to N and each of the target images 1 to N increases. In the example in FIG. 5, a fitness of an individual of a filter structure 1 (=0.9) is higher than a fitness of an individual of a filter structure 2 (=0.6).

Next, survival selection is performed as illustrated in FIG. 3. First, a single individual is determined according to the fitness. For example, an individual having the highest fitness is determined as a best individual. Furthermore, an individual is determined by random selection by using a roulette. Next, the plurality of determined individuals is replaced with the individuals in the parent population. Next, in the parent population, if the maximum value of the fitness of each individual exceeds a threshold, the individual of which the fitness exceeds the threshold is saved as the best individual.

From the above, by preparing the set of the original images and the set of the target images as the learning data, it is possible to automatically construct the optimal image processing program. Furthermore, by preparing the plurality of sets of original images and the plurality of sets of target images in different imaging environments, it is possible to automatically configure a robust image processing program.

In order to automatically configure the robust image processing program, a plurality of original images that considers a change in the imaging environment (for example, variation in brightness) is set as the learning data, and a tree structure of which the fitness is high in all the pieces of learning data is searched by the genetic programming. An average of the evaluation values calculated for each group of the learning data can be used. However, with the evaluation method using the average, there is a possibility that selection is performed on the tree structure that is highly evaluated in a specific imaging environment.

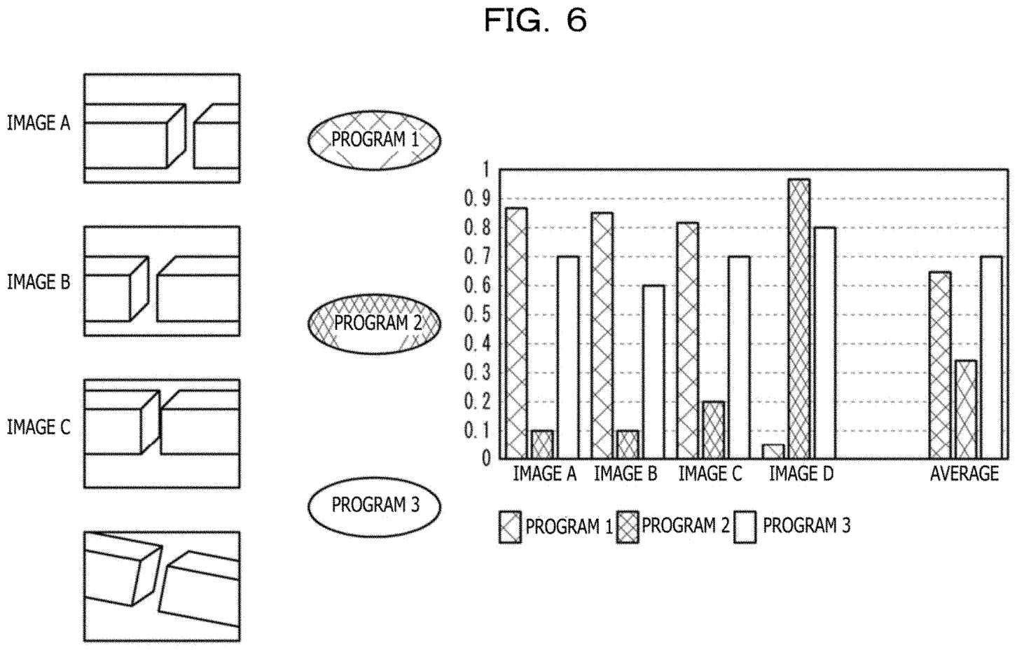

For example, as illustrated in FIG. 6, when pieces of learning data of image processing programs 1 to 3 are evaluated by using original images A to D, it is assumed that the image processing program 1 have high rating with respect to the original images A to C and the image processing program 2 have high rating with respect to the original image D. It is assumed that, although the image processing program 3 has lower rating with respect to all the original images than the other image processing programs, the image processing program 3 has the highest average of the evaluation values. In this case, by using the evaluation method using the average described above, the image processing program 3 remains in the next generation through the survival selection, and the image processing programs 1 and 2 that have high rating in the specific environment are eliminated. Therefore, there has been a problem in that, in the evaluation method using the average, construction of a versatile tree structure precedes and a learning speed before acquisition of desired accuracy is slow. Therefore, it is necessary to perform learning for a long time or to learn divided learning data a plurality of times, and establishment of an efficient learning method is required.

Therefore, in the following embodiment, an information processing device, an information processing method, and an information processing program that can automatically generate an image processing program with high accuracy in a short time will be described.

### First Embodiment

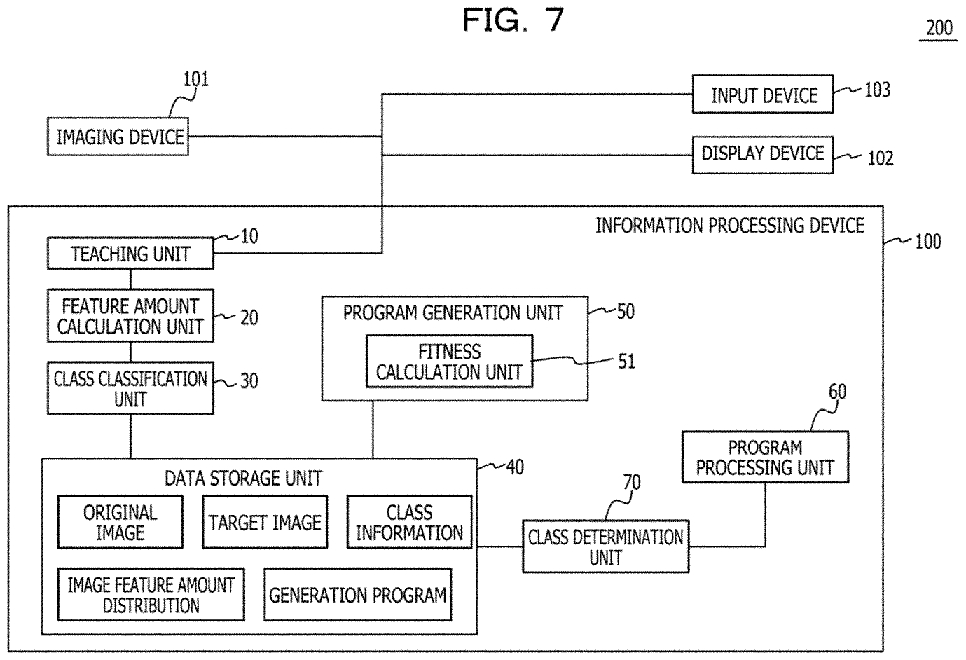

FIG. 7 is a block diagram illustrating an entire configuration of an image processing apparatus 200 according to a first embodiment. As illustrated in FIG. 7, the image processing apparatus 200 includes an information processing device 100, an imaging device 101, an input device 102, a display device 103, or the like. The information processing device 100 includes a teaching unit 10, a feature amount calculation unit 20, a class classification unit 30, a data storage unit 40, a program generation unit 50, a program processing unit 60, a class determination unit 70, or the like. The program generation unit 50 includes a fitness calculation unit 51.

The imaging device 101 is a device such as a camera. The imaging device 101 captures an image of an object. The object is an inspection target. The input device 102 is a device used to input an image type (original image, target image, and inspection image) of an image to be input to the information processing device 100 and is a keyboard, a mouse, or the like. The display device 103 is a device that displays a processing result by the information processing device 100 and is a liquid crystal display or the like.

An image acquired by the imaging device 101 is input to the information processing device 100 as an input image. A user inputs an image type of the input image by using the input device 102. The teaching unit 10 associates the input image with the image type. In learning processing, each input image is input as learning data. An original image or a target image is associated with each input image. The data storage unit 40 stores the input image associated with the image type. For example, the original image and the target image obtained from the original image are stored as a pair. In a case where the plurality of original images and the plurality of target images are input, target images 1 to N corresponding to original images 1 to N are stored with respect to the original images 1 to N.

(Learning Processing)

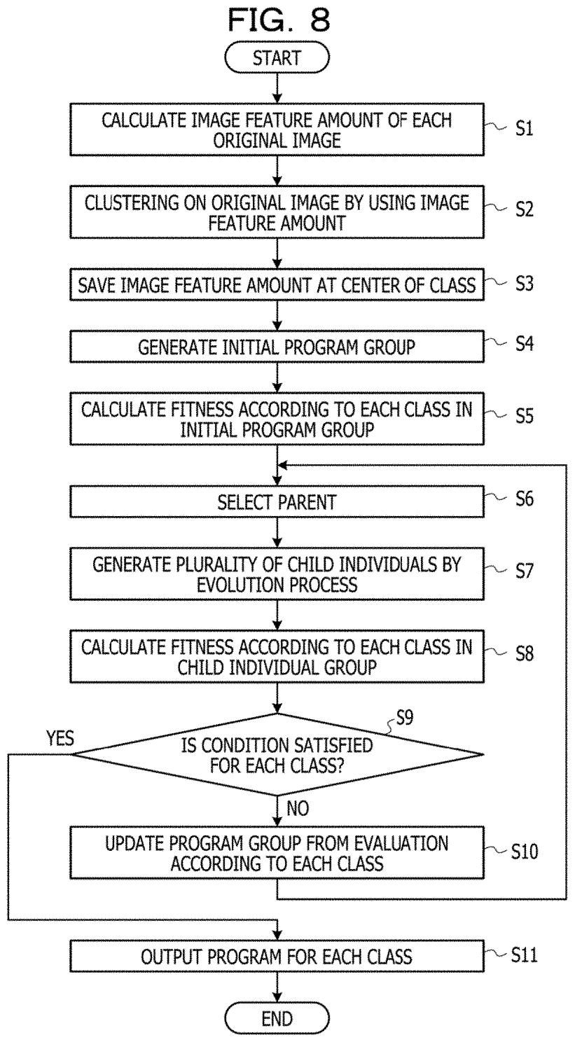

FIG. 8 is a diagram illustrating a flowchart indicating each processing executed by the information processing device 100 at the time of learning processing. Hereinafter, the learning processing will be described with reference to FIG. 8. First, the feature amount calculation unit 20 calculates an image feature amount of each of the original images 1 to N stored in the data storage unit 40 (step S1). For example, an image processing program is a combination of spatial filters in image processing and tree structures in threshold processing. Image processing by the image processing program is executed on an entire image. Therefore, in the present embodiment, image features of the original image are considered as brightness and sharpness of the entire image, and a luminance histogram of the image, spatial frequency information, or the like are used as the image feature amount.

The class classification unit 30 performs clustering on the original images 1 to N by a K-means method or the like by using the image feature amount calculated by the feature amount calculation unit 20 (step S2). With this operation, the class classification unit 30 classifies the original images 1 to N into each class. The data storage unit 40 associates each of the original images 1 to N to a class to which each of the original images 1 to N belongs and stores the associated information as class information. Furthermore, the data storage unit 40 associates distribution of the image feature amounts of the original images 1 to N and an image feature amount to be the center of each class with each class and stores the associated information as image feature amount distribution (step S3).

Next, the program generation unit 50 generates a plurality of initial individuals as a parent population group (initial program group) by using the original images 1 to N (step S4). The generated program is stored in the data storage unit 40. Step S4 corresponds to the generation of the initial individual in FIG. 3. Next, the fitness calculation unit 51 calculates a fitness (evaluation value) for each individual in the parent population for each class by using the original image that has been classified into each class (step S5). For example, in a case where a class 1 includes the original images 1 to 3, an average value or the like of similarity between respective output images 1 to 3 in a case where image processing is executed on the original images 1 to 3 and the respective target images 1 to 3 is calculated as the fitness.

Next, the program generation unit 50 determines a parent in the next generation (step S6). For example, the program generation unit 50 randomly determines individuals as many as the number of classes M by using uniform random numbers from the parent population.

Next, the program generation unit 50 generates a plurality of child individuals by an evolution process (crossover and mutation) from the parent selected in step S6 (step S7). For example, two individuals are selected by using the uniform random numbers from the M individuals selected in step S6, and crossover is performed. Next, the fitness calculation unit 51 calculates a fitness of each child individual for each class (step S8). Next, the program generation unit 50 determines whether or not a condition is satisfied for each class (step S9). For example, it is determined whether or not a maximum value of the fitness of the child individual is equal to or more than a threshold for each class.

In a case where it is determined in step S9 as “No”, the program generation unit 50 selects a plurality of child individuals from a child individual group depending on distribution of the evaluation values for each class and replaces the selected child individuals with the parent population, and thereby updates the parent population (step S10). As a selection method in this case, for example, roulette selection according to the M child individuals of which the evaluation value becomes maximum in each class, the evaluation value, or the like can be used. For example, roulette selection can be performed in which a possibility to be selected is higher as the evaluation value increases and the possibility to be selected is lower as the evaluation value decreases. For example, the M child individuals selected in step S10 are replaced with the individuals determined in step S6. Thereafter, the procedure from step S6 is performed again. In a case where it is determined in step S9 as “Yes”, the program generation unit 50 outputs an individual (image processing program) having the maximum fitness for each class (step S11). The output image processing program is associated with each class and stored in the data storage unit 40.

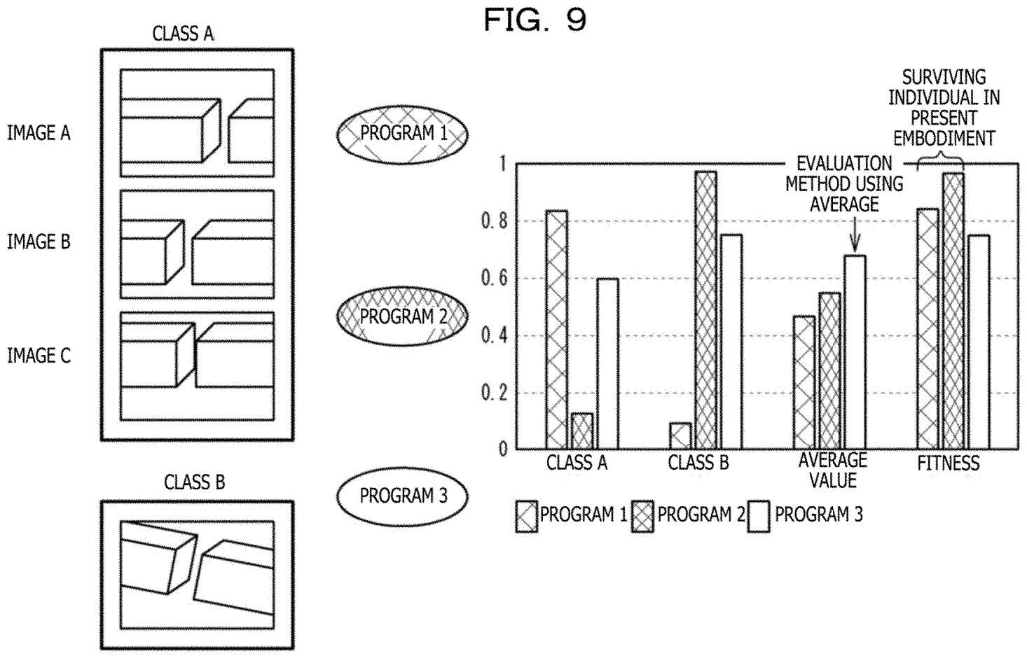

FIG. 9 is a diagram illustrating an outline of the learning processing described above. As illustrated in FIG. 9, by performing clustering on the original images A to D, it is assumed that the original images A to C belong to a class A and the original image D belongs to a class B. A fitness of each of the image processing programs 1 to 3 obtained by the evolution process is calculated for each class. The image processing program 1 has a high fitness with respect to the class A. The image processing program 2 has a high fitness with respect to the class B. The image processing program 3 has an average fitness with respect to both of the classes A and B. At the average value with respect to the classes A and B, the image processing program 3 has the highest fitness. Therefore, in a case of the evaluation method using the average, the image processing program 3 is a surviving individual. On the other hand, in the present embodiment, the image processing program 1 is a surviving individual with respect to the class A, and the image processing program 2 is a surviving individual with respect to the class B. Therefore, according to the present embodiment, an image processing program that is significantly effective for some learning data remains in the next generation without being eliminated.

(Inspection Processing)

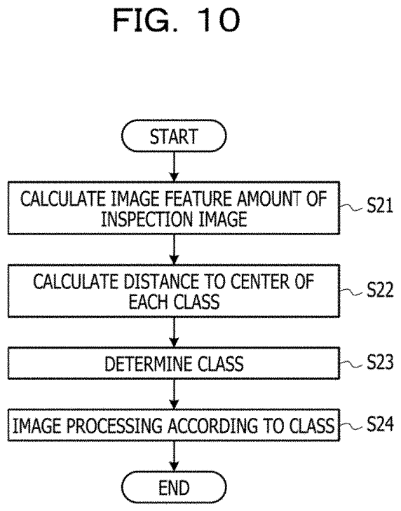

FIG. 10 is a diagram illustrating a flowchart indicating each processing executed by the information processing device 100 at the time of inspection processing. Hereinafter, the inspection processing will be described with reference to FIG. 10. An image of an inspection target acquired by the imaging device 101 is input to the information processing device 100 as an input image. In the inspection processing, the teaching unit 10 sets the type of the input image as an inspection image. The feature amount calculation unit 20 calculates an image feature amount from the inspection image (step S21). A type of the image feature amount in this case is the same as the image feature amount used in the learning processing. The class determination unit 70 calculates a distance between the image feature amount at the center of each class stored in the data storage unit 40 and the image feature amount calculated in step S21 (step S22). For example, a Euclidean distance, a Mahalanobis distance, or the like from the image feature amount at the center of the class can be used.

Next, the class determination unit 70 determines a class having the shortest distance as a target class (step S23). Next, the program processing unit 60 executes image processing on the inspection image by using an image processing program of the target class determined in step S23 among the image processing programs stored in the data storage unit 40 (step S24). Thereafter, for example, quality determination or the like is performed.

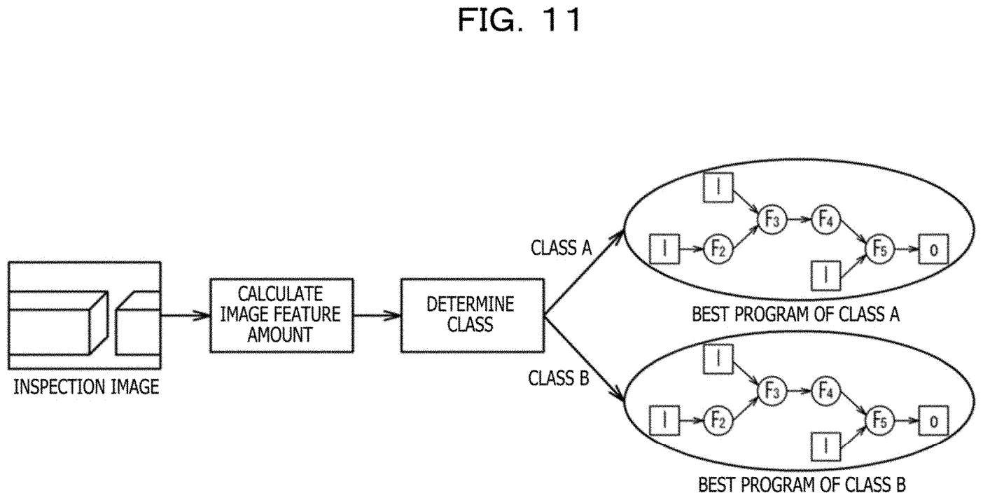

FIG. 11 is a diagram illustrating an outline of the inspection processing described above. As illustrated. In FIG. 11, an image feature amount is calculated from the inspection image. A class is determined by using the calculated image feature amount. In a case where it is determined that the inspection image belongs to the class A, image processing is executed by using the best image processing program in the class A. In a case where it is determined that the inspection image belongs to the class B, the image processing is executed by using the best image processing program in the class B. As a result, appropriate image processing is executed.

According to the present embodiment, by performing clustering on the original image by using the image feature amount calculated from the plurality of original images for learning, the original image is classified into each class. For each classified class, a fitness of the image processing program with respect to the original image is calculated as an evaluation value. An image processing program is generated by using the genetic programming on the basis of the evaluation value calculated for each class, and the image processing program of which the evaluation value satisfies a predetermined condition is associated with each class and stored. According to this configuration, at the time of learning processing, a plurality of image processing programs with high accuracy according to characteristics of the learning data can be constructed in a short time (for example, single-time of learning). Furthermore, at the time of inspection processing, it is possible to selectively execute the image processing program with high accuracy according to the image feature amount of the inspection Image. In particular, in a case where the evaluation is made by using the average, know-how has been required for selecting learning data. However, in the present embodiment, it is possible to perform learning without considering a difference in the image features of the learning data. As a result, it is possible to construct a high-performance image processing program by simple image teaching without a specialist, and early construction of a production line when changing stages or quick improvement against an abnormal operation are possible.

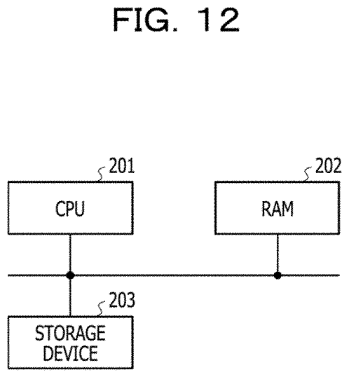

FIG. 12 is a block diagram for explaining a hardware configuration of the information processing device 100. As illustrated in FIG. 12, the information processing device 100 includes a CPU 201, a RAM 202, a storage device 203, or the like. The Central Processing Unit (CPU) 201 is a central processing unit. The CPU 201 includes one or more cores. The Random Access Memory (RAM) 202 serves as a volatile memory that temporarily stores a program to be executed by the CPU 201, data to be processed by the CPU 201, and the like. The storage device 203 serves as a non-volatile storage device. Examples of the storage device 203 that can be used include a Read Only Memory (ROM), a solid state drive (SSD) such as a flash memory, and a hard disk driven by a hard disk drive. The storage device 203 stores an information processing program. By executing the information processing program stored in the storage device 203 by the CPU 201, each unit of the information processing device 100 is realized. Note that each unit of the information processing device 100 may be hardware such as a dedicated circuit.

In the above embodiment, the feature amount calculation unit 20 functions as an example of a feature amount calculation unit that calculates an image feature amount from a plurality of original images for learning. The class classification unit 30 functions as an example of a classification unit that classifies the plurality of original images into each class by performing clustering on the plurality of original images by using the image feature amount. The fitness calculation unit 51 functions as an example of an evaluation unit that calculates an evaluation value of an image processing program with respect to the plurality of original images for each class classified by the classification unit. The program generation unit 50 functions as an example of a program generation unit that generates an image processing program by genetic programming on the basis of the evaluation value calculated for each class. The data storage unit 40 functions as an example of a storage unit that stores an image processing program of which the evaluation value satisfies a predetermined condition in association with each class.

The embodiment of the present invention has been described in detail. However, the present invention is not limited to such a specific embodiment, and various modifications and alterations can be made within the scope of gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
calculate an image feature amount from a plurality of original images for learning;
classify the plurality of original images into each class by performing clustering on the plurality of original images by using the image feature amount;
calculate an evaluation value of an image processing program with respect to the plurality of original images for each class;
generate an image processing program by genetic programming on a basis of the evaluation value calculated for each class; and
store an image processing program of which the evaluation value satisfies a predetermined condition in association with each class.

2. The information processing device according to claim 1, wherein
the processor calculates a maximum value of the evaluation value as an evaluation value of the image processing program for each class.

3. The information processing device according to claim 1, wherein
the processor uses an image processing program having the maximum evaluation value in each class as a parent in a next generation at the time of survival selection when the image processing program is generated by using the genetic programming.

4. The information processing device according to claim 1, wherein
the processor performs clustering by using the calculated image feature amount with respect to an inspection image, and
acquires the image processing program associated with the class obtained by the clustering from the memory and execute image processing on data of the inspection image by the image processing program.

5. An information processing method comprising:
Calculating, by a computer, an image feature amount from a plurality of original images for learning;
classifying the plurality of original images into each class by performing clustering on the plurality of original images by using the image feature amount;
calculating an evaluation value of an image processing program with respect to the plurality of original images for each class;
generating an image processing program by genetic programming on a basis of the evaluation value calculated for each class; and
storing an image processing program of which the evaluation value satisfies a predetermined condition in association with each class in a memory.

6. A non-transitory computer-readable recording medium recording an information processing program for causing a computer to execute:
processing for calculating an image feature amount from a plurality of original images for learning;
processing for classifying the plurality of original images into each class by performing clustering on the plurality of original images by using the image feature amount;
processing for calculating an evaluation value of an image processing program with respect to the plurality of original images for each classified class;
processing for generating an image processing program by genetic programming on a basis of the evaluation value calculated for each class; and
processing for storing an image processing program of which the evaluation value satisfies a predetermined condition in association with each class.
